(19) United States
(12) Patent Application Publication
(10) Pub. No.: US 2019/0107673 A1
(43) Pub. Date: Apr. 11, 2019

(54) POLARIZATION DISPERSION MITIGATION

(71) Applicant: Google LLC, Mountain View, CA (US)

(72) Inventors: Lieven Verslegers, San Francisco, CA (US); Mohammad Sotoodeh, Livermore, CA (US); Ryohei Urata, San Carlos, CA (US)

(21) Appl. No.: 16/131,594

(22) Filed: Sep. 14, 2018

Related U.S. Application Data
(60) Provisional application No. 62/570,952, filed on Oct. 11, 2017.

(51) Int. Cl. G02B 6/126; G02B 6/122

(52) U.S. Cl. CPC G02B 6/126; G02B 2006/12061; G02B 6/1228

(57) ABSTRACT

Silicon-on-insulator photonic integrated circuits (PICs) are provided. A PIC can include a silicon dioxide substrate surrounding a silicon waveguide. The silicon waveguide has a thickness between an upper side and a lower side and a width between lateral sides. The thickness and width can be set such that a first group index of a lowest-order TE mode of an optical signal is approximately equal to a second group index of a lowest-order TM mode of the optical signal.

### RELATED APPLICATIONS

The present application claims priority to, and the benefit of, U.S. Provisional Patent Application No. 62/570,952, titled “POLARIZATION DISPERSION MITIGATION” and filed on Oct. 11, 2017, the entire contents of which are hereby incorporated by reference for all purposes.

### BACKGROUND

Silicon photonics is an emerging technology that promises to deliver low-cost, low-power, high-speed optical solutions for datacom and telecom. This technology enables scaling of transceiver channels and speeds through photonic/electronic integration. Some silicon photonic integrated circuits (PICs) and components fabricated using a standard silicon on insulator (SOI) technology platform having a silicon layer thickness of approximately 220 nm may display strong polarization dependence. Hence, silicon PICs usually operate using the fundamental transverse electric (TE) waveguide mode only.

### SUMMARY

At least one aspect is directed to a silicon-on-insulator (SOI) photonic integrated circuit (PIC). The SOI PIC includes a silicon dioxide substrate surrounding a silicon waveguide. The silicon waveguide has a thickness between an upper side and a lower side and a width between lateral sides. The thickness and width are set such that a first group index of a lowest-order TE mode of an optical signal is approximately equal to a second group index of a lowest-order TM mode of the optical signal.

In some implementations, the thickness and the width of the silicon waveguide are such that the silicon waveguide substantially attenuate higher-order TE and TM modes of the optical signal.

In some implementations, the thickness and the width of the silicon waveguide are such that the silicon waveguide does not excite higher-order modes of the optical signal.

In some implementations, the optical signal has a wavelength of 1550 nm. In some implementations, the thickness is approximately 220 nm and the width between the lateral sides is approximately 670 nm.

In some implementations, the optical signal has a wavelength of 1310 nm. In some implementations, the thickness is approximately 220 nm and the width between the lateral sides is approximately 320 nm.

In some implementations, the silicon waveguide includes a middle section, a first taper at a first end of the middle section, and a second taper at a second end of the middle section opposite the first end. In some implementations, the first taper joins the middle section with a first end section having a different width than the middle section, the first taper joining the lateral sides of the middle section with lateral sides of the first end section. In some implementations, the second taper joins the middle section with a second end section having a different width than the middle section, the second taper joining the lateral sides of the middle section with lateral sides of the second end section.

In some implementations, the middle section has a thickness of approximately 220 nm and a width of approximately 320 nm, the first taper has a length of approximately 2 um, and the second taper has a length of approximately 2 um. In some implementations, the first end section is coupled with an edge coupler for receiving the optical signal and conveying it to the silicon waveguide, and the second section is coupled with a photo detector for detecting the optical signal received at the edge coupler.

In some implementations, the middle section has a thickness of approximately 220 nm and a width of approximately 670 nm, the first taper has a length of approximately 2 um, and the second taper has a length of approximately 2 um. In some implementations, the first end section is coupled with an edge coupler for receiving the optical signal and conveying it to the silicon waveguide, and the second section is coupled with a photo detector for detecting the optical signal received at the edge coupler.

In some implementations, the width relates to the thickness for a given wavelength WL according to the following formula where Wo is the width and s is a scaling factor for the thickness t such that s=t/0.22:

Wₒ=[0.194+0.000114*e^{5.373*WL/s}+4.96*10⁻³⁰*e^{40.7*WL/s}]*s

In some implementations, the wavelength is greater than the greater of 1.26 um and 1.26*s and less than the lesser of 1.62 um or 1.62*s.

At least one aspect is directed to a polarization dispersion mitigating waveguide. The polarization dispersion mitigating waveguide includes a silicon waveguide surrounded by silicon dioxide on its upper, lower, and lateral sides, the silicon waveguide having a thickness of approximately 220 nm between the upper side and the lower side and a width of approximately 320 nm between the lateral sides.

In some implementations, a first group index of a lowest-order TE mode of an optical signal having a wavelength of 1310 nm is approximately equal to a second group index of a lowest-order TM mode of the optical signal.

At least one aspect is directed to a polarization dispersion mitigating waveguide. The polarization dispersion mitigating waveguide includes a silicon waveguide surrounded by silicon dioxide on its upper, lower, and lateral sides, the silicon waveguide having a thickness of approximately 220 nm between the upper side and the lower side and a width of approximately 670 nm between the lateral sides.

In some implementations, a first group index of a lowest-order TE mode of an optical signal having a wavelength of 1550 nm is approximately equal to a second group index of a lowest-order TM mode of the optical signal.

In some implementations, the width relates to the thickness for a given wavelength WL according to the following formula where Wo is the width and s is a scaling factor for the thickness t such that s=t/0.22:

Wₒ=[0.194+0.000114*e^{5.373*WL/s}+4.96*10⁻³⁰*e^{40.7*WL/s}]*s

In some implementations, the wavelength is greater than the greater of 1.26 um and 1.26*s and less than the lesser of 1.62 um or 1.62*s.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 illustrates a photonic integrated circuit, according to an illustrative implementation;

FIG. 2 illustrates a photonic integrated circuit in a transceiver module, according to an illustrative implementation;

FIG. 3 shows a cross section of an optical waveguide in a silicon-on-insulator wafer, according to an illustrative implementation;

FIGS. 4A-4D show simulated (A and B) and measured (C and D) group index values for TE (A and C) and TM (B and D) modes of a 1310 nm wavelength laser in 220 nm thick waveguides of different widths, according to an illustrative implementation;

FIG. 5 shows simulated TE-TM delay difference values for a 1310 nm wavelength laser in 220 nm thick waveguides of different widths, according to an illustrative implementation;

FIGS. 6A-D show simulated (A and B) and measured (C and D) group index values for TE (A and C) and TM (B and D) modes of a 1550 nm wavelength laser in 220 nm thick waveguides of different widths, according to an illustrative implementation;

FIG. 7 shows simulated TE-TM delay difference values for a 1550 nm wavelength laser in 220 nm thick waveguides of different widths, according to an illustrative implementation;

FIG. 8 shows the optimal waveguide width versus laser wavelength for reducing TE-TM delay difference values according to simulated values of TE and TM delay in a 220 nm thick waveguide, according to an illustrative implementation;

FIG. 9 shows the results of direct delay measurements of TE and TM delay through 220 nm thick waveguides of various widths for both TE and TM modes of a 1550 nm laser, according to an illustrative implementation;

FIG. 10 illustrates a top view of a compound waveguide including a polarization dispersion-mitigating waveguide with waveguide tapers, according to an illustrative implementation;

FIGS. 11A and 11B show simulated (A) and measured (B) group index values for TE modes of a 1.5-1.6 um wavelength laser in approximately 204.4 nm thick waveguides of different widths ranging from 0.45-1.25 um, according to an illustrative implementation; and

FIGS. 11C and 11D show simulated (C) and measured (D) group index values for TM modes of a 1.5-1.6 um wavelength laser in approximately 204.4 nm thick waveguides of different widths ranging from 0.45-1.25 um, according to an illustrative implementation.

### DETAILED DESCRIPTION

This disclosure generally relates to polarization dispersion mitigation in a silicon-on-insulator (SOI) waveguide. Silicon photonic integrated circuits (PICs) usually operate using the fundamental transverse electric (TE) waveguide mode only; however, PICs may receive a random combination of TE and TM modes at the receiver. The PIC must be able to handle both modes. One challenge for handling an optical signal of unknown polarization arises from having to convey the optical signal across the PIC via a waveguide. For example, the PIC may receive the optical signal at edge couplers on one side of the PIC, and convey the optical signal to photodetectors on the other side of the PIC. A standard, single-mode silicon waveguide may convey light of different polarizations at different velocities. As a result, the TE and TM components of the light pulse will experience a relative delay difference of several ps/mm, and potentially >10 ps difference for propagation across the PIC. This effect can be referred to as polarization dispersion. For current and next generation symbol rates of 25 and 50 Gbaud/s, symbol periods are 40 ps and 20 ps respectively. With these symbol periods and typical PIC dimensions, the polarization dispersion can cause increased bit error rates. This effect will worsen with increasing symbol rates. Carefully adjusting the width of the waveguide, however, can reduce the difference in TE and TM mode velocities, and thus mitigate the polarization dispersion.

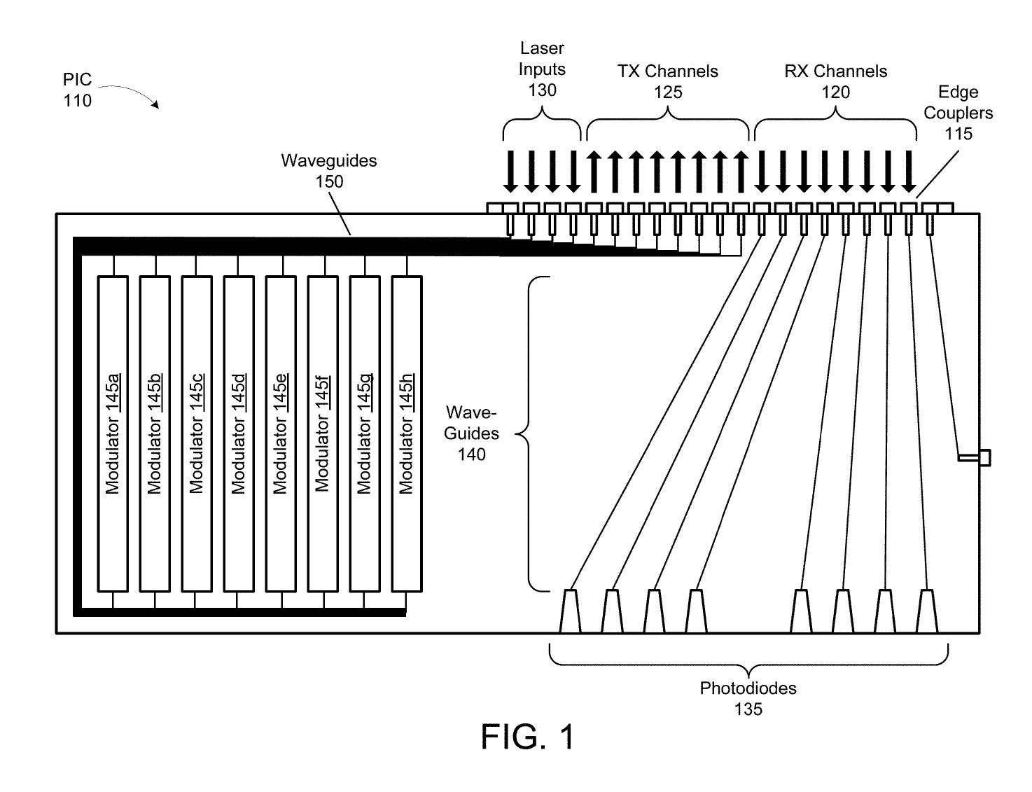

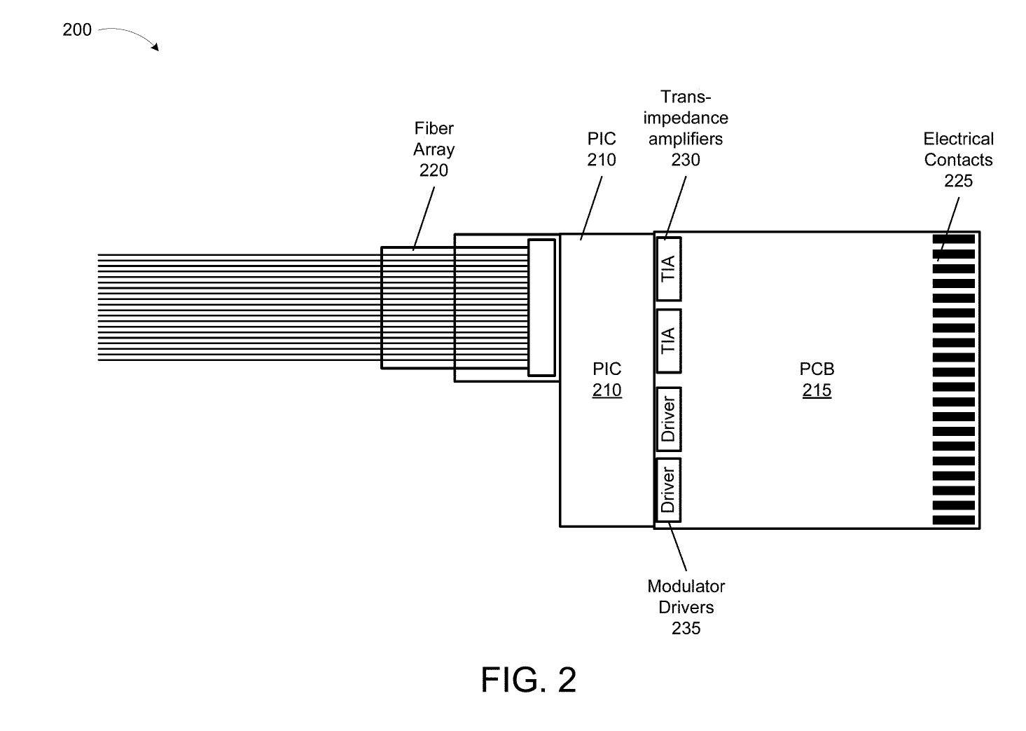

FIG. 1 illustrates a photonic integrated circuit (PIC) 110, according to an illustrative implementation. The PIC 110 includes a number of edge couplers 115 for receiving and transmitting optical signals such as incoming receive (RX) channels 120, outgoing transmit (TX) channels 125, and laser inputs 130. The edge couplers 115 can receive the laser inputs 130 and convey them via waveguides 150 to modulators 145a-145h (collectively, “modulators 145”) for modulating with optical signals. Additional waveguides 150 can convey the modulated optical signals to the edge couplers 115 for transmitting the TX channels 125. The PIC 110 also includes photo detectors such as photodiodes 135 for detecting optical signals received at the RX channel 120 edge couplers 115. In some implementations, the PIC 110 may include additional elements such as grating couplers, splitters, multiplexers/demultiplexers, monitor photodiodes, etc. In some implementations, the PIC 110 may include electrical components such as modulator drivers, amplifiers, and control circuits. The optical signals can be conveyed from the edge couplers 115 to the photodiodes 135 by waveguides 140. The photodiodes 135 may need to be placed on the far edge of the PIC 110 from the edge couplers 115 due to a desire to reduce the lengths of electrical connections between the photodiodes 135 and their respective transimpedance amplifiers and between the transimpedance amplifiers and the electrical contact 225, which may reside on an optical transceiver module of which the PIC 110 is a part. An example optical transceiver module is described below with reference to FIG. 2. Challenges may arise, however, when received optical signals of unknown polarization travel through the waveguides 140.

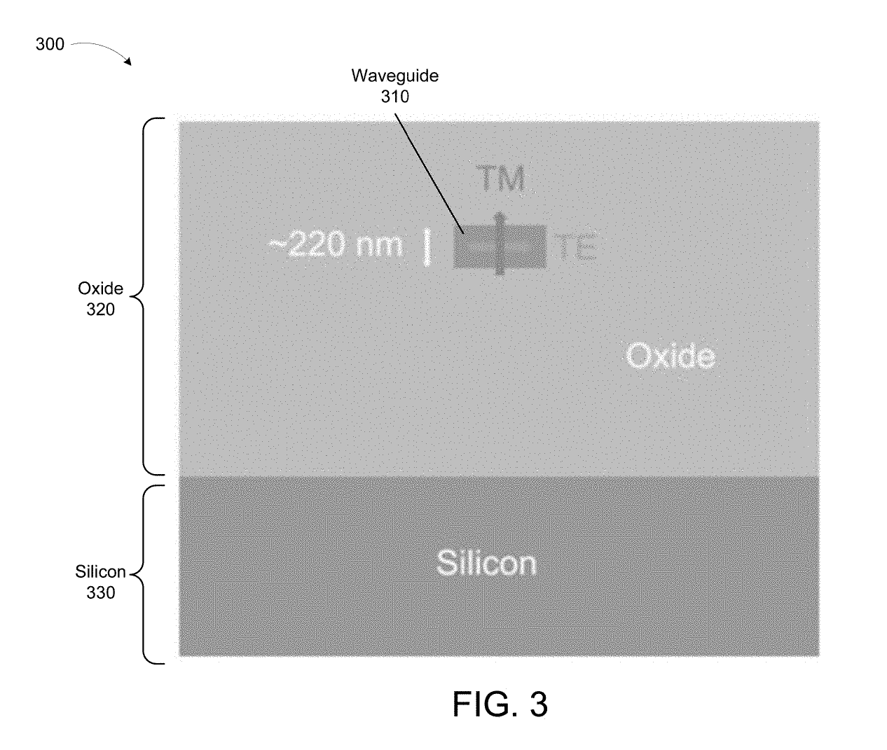

A standard waveguide 140 or 150 may be designed to carry a single TE mode of an optical signal. For example, silicon PICs and components are often fabricated on a standard SOI wafer, which can be used to make waveguides having a thickness of approximately 220 nm. In practice, 220 nm will be the typical starting thickness for the silicon layer in the SOI wafer. Following the fabrication process, however, the thickness of the ultimate waveguide may be reduced by several nanometers due to oxidation. Therefore, the final waveguide may be slightly less than 220 nm; for example, 210-220 nm. A corresponding width of a standard waveguide could be set to 450-500 nm for a 1550 nm optical signal, or 380-420 nm for a 1310 nm optical signal. When the received optical signal is of unknown polarization, however, both the TE and a TM mode will travel through the waveguides 140. The TE and TM modes travel at different speeds through a standard waveguide, resulting in polarization dispersion that can cause bit errors in some cases. Therefore, in some implementations, the waveguides 140 can include features that mitigate polarization dispersion. The polarization dispersion mitigation of the waveguides 140 is described in further detail below with reference to FIGS. 3-10. In contrast, the waveguides 150 may not require, or benefit from, polarization mitigation for the simple reason that polarization of the optical signals from the laser inputs 130 and the modulator 145 outputs can be controlled, or is at least knowable. The optical signals received from RX channels 120, however, may have unknown polarizations that can experience problematic polarization dispersion while traveling through the waveguides 140 to the photodiodes 135.

FIG. 2 illustrates photonic integrated circuit (PIC) 210 in a transceiver module 200, according to an illustrative implementation. The optical transceiver module 200 includes the PIC 210, a printed circuit board (PCB) 215, transimpedance amplifiers (TIAs) 230, modulator drivers 235, and electrical contacts 225. The PIC 210 can be, for example, the PIC 110 described previously. The PIC 210 can receive a fiber array 220 conveying RX and TX channels, such as the RX channels 120 and the TX channels 125. The TIAs 230 can buffer and/or amplify electrical signals from photodetectors on the PIC 210. The modulator drivers 235 can provide power to the modulators 145 for modulating the electrical signal onto the optical carrier. The PCB 215 can house any processor, controller, driver, or power conversion circuitry helpful for supporting the functions of the PIC 210. The electrical contacts 225 can include signal contacts for transmitting and receiving electrical signals converted from, or for conversion to, optical signals transmitted along the fiber array 220. The electrical contacts 225 can also connect to power supply and ground rails. In some implementations, the optical transceiver module 200 may include electrical components such as modulator drivers, amplifiers, and control circuits. In some implementations, the optical transceiver module 200 can be a modular component of a larger optical device such as an optical switch, gateway, or reconfigurable optical add/drop multiplexer.

FIG. 3 shows a cross section of an optical waveguide 310 in a silicon-on-insulator (SOI) wafer 300, according to an illustrative implementation. The waveguide 310 includes a region of silicon surrounded on its upper, lower, and lateral sides by an oxide such as silicon dioxide (SiO₂). The waveguide 310 can be in the shape of a rectangular prism elongated along an axis perpendicular to the plane of the cross section shown in FIG. 3, where respective planes of the upper, lower, and lateral sides are perpendicular to the axis. In some implementations, however, the lateral sides may not be perfectly parallel to each other along a vertical axis. In some implementations, a slight widening from bottom to top may be introduced due to the fabrication process used to make the waveguide 310. In some implementations, the silicon-oxide-silicon structure of the SOI wafer 300 can be formed by a standard SOI fabrication process resulting in a waveguide 310 thickness of 220 nm. While other thicknesses of the silicon waveguide 310 are possible, they may be difficult or costly to make due to standards for SOI fabrication.

SOI waveguides, such as the waveguide 310, are typically sized to carry only a lowest-order TE mode of an optical signal, while being kept small enough to attenuate or reject higher-order modes. When the waveguide 310 conveys an optical signal received in a PIC, however, the optical signal may have an unknown polarization due to shifts in polarization occurring while the signal traversed an optical fiber on the way to the SOI wafer 300. Thus, the waveguide 310 may end up carrying both TE and TM modes of the optical signal. A standard, single-mode silicon waveguide, however, may convey the TE and TM modes of an optical signal at different velocities. As a result, the TE and TM components of the optical signal may experience a relative delay difference of several ps/mm, and potentially >10 ps difference for propagation across the PIC, resulting in polarization dispersion of the optical signal. A 25 Gbaud/s optical signal will have a symbol period of 40 ps. Thus, 10 ps or more of polarization dispersion may cause bit error rates, with the effect worsening with increasing symbol rates. Carefully adjusting the width of the waveguide, however, can reduce the difference in TE and TM mode group indices, and thus mitigate the polarization dispersion. The group index, or group refractive index, (n_{g}) of a material can be defined as the ratio of the vacuum velocity of light to the group velocity in the medium:

$${n}_{g} = \frac{c}{{v}_{g}} .$$

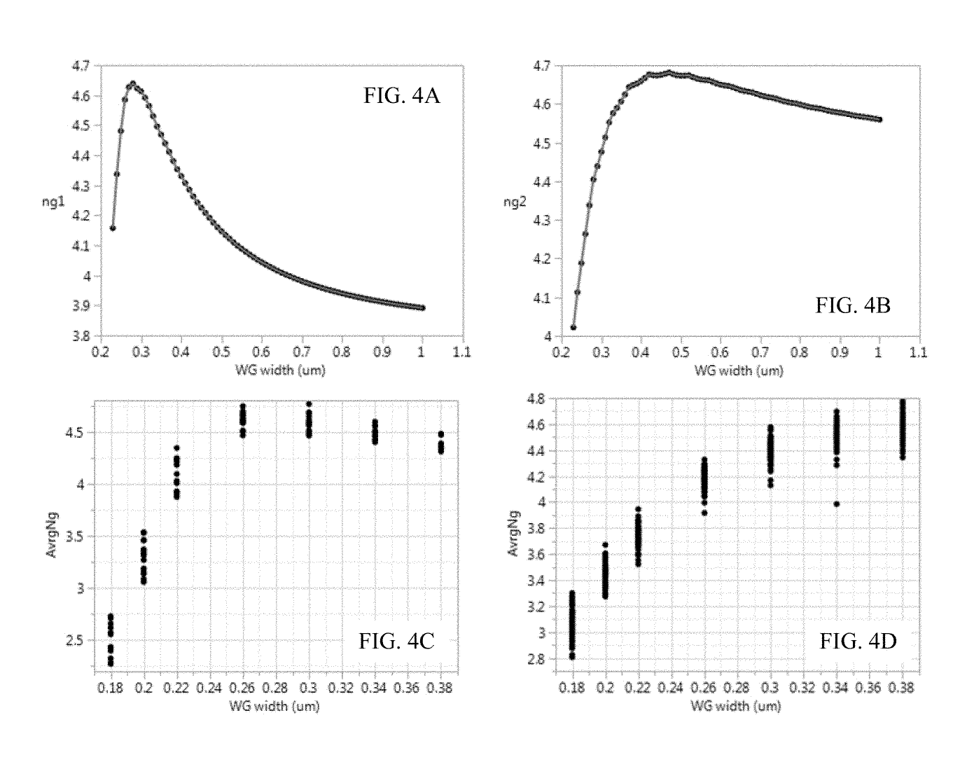

dimensions or the waveguide 310 can be chosen such that TE and TM modes have the same group index, polarization dispersion due to the respective velocities of the TE and TM modes can be mitigated. FIGS. 4-9 show the results of simulations and measurements of TE and TM mode group index in waveguides of various widths.

FIGS. 4A-4D show simulated (A and B) and measured (C and D) group index values for TE (A and C) and TM (B and D) modes of a 1310 nm wavelength laser in 220 nm thick waveguides of different widths, according to an illustrative implementation. The simulations shown in FIGS. 4A and 4B were validated by establishing the group index experimentally using imbalanced Mach-Zehnder interferometer test structures. The results are in close agreement with the simulations, if measurement noise and uncertainty in waveguide dimensions due to lithography tolerances are taken into account. Note, however, the difference in horizontal scale between 4A and 4C, and 4B and 4D, respectively.

FIG. 4A shows simulated group index values for the lowest order TE mode (“ng_TE”) for a 1310 nm wavelength laser traveling in through 220 nm thick waveguides of different widths. FIG. 4C shows group index measurements under experimental conditions meant to replicate the simulation parameters. Similarly, FIGS. 4B and 4D respectively show simulated and measured group index values for the lowest order TM mode (“ng_TM”) under similar conditions.

FIGS. 4A-D show that the group index of the lowest-order TE and TM modes for a 1310 nm laser are roughly equivalent in a 220 nm thick waveguide having a width of 320 nm. Therefore, these simulations and measurements suggest that a 220×320 nm waveguide would exhibit reduced polarization dispersion for a 1310 nm laser. Thus, in some implementations, a dispersion-mitigating waveguide could have a thickness of approximately 220 nm and a width of approximately 320 nm. In some implementations, the dispersion-mitigating waveguide could have a thickness of approximately 220 nm and a width of approximately 290-350 nm. In some implementations, the dispersion-mitigating waveguide could have a thickness of approximately 220 nm and a width of approximately 240-400 nm.

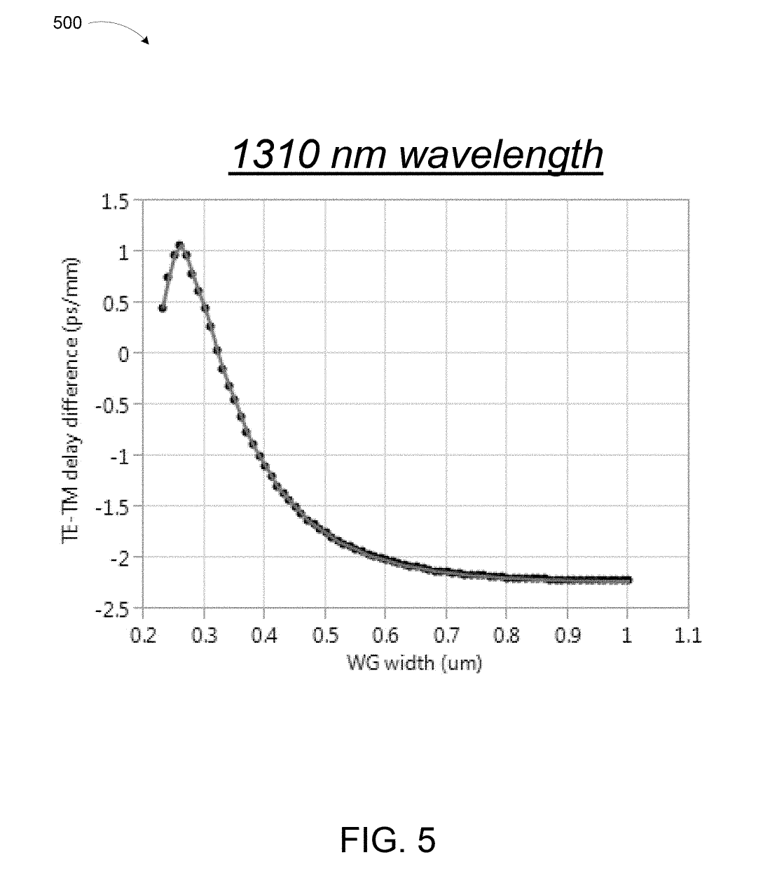

FIG. 5 shows simulated TE-TM delay difference values for a 1310 nm wavelength laser in 220 nm thick waveguides of different widths, according to an illustrative implementation. FIG. 5 represents the simulated group index values from FIG. 4A minus the simulated group index values from FIG. 4B at each simulated waveguide width. FIG. 5 shows that the lowest-order TE and TM modes, respectively, for a 1310 nm laser should have equivalent or approximately equivalent group index values in a 220×320 nm waveguide.

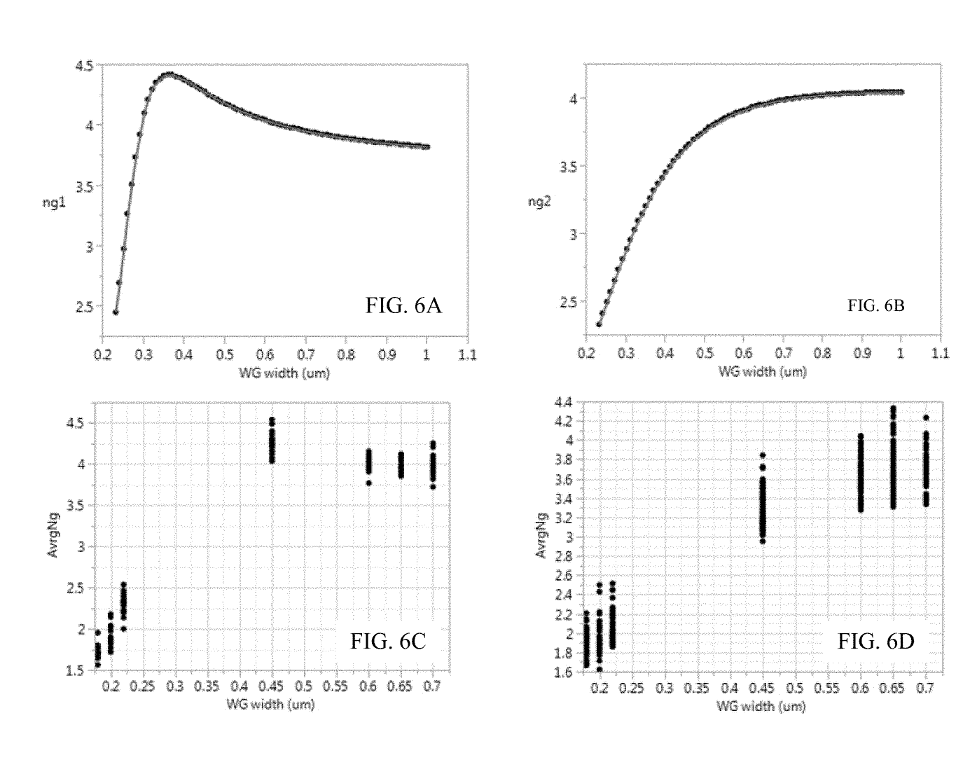

FIGS. 6A-6D show simulated (A and B) and measured (C and D) group index values for TE (A and C) and TM (B and D) modes of a 1550 nm wavelength laser in 220 nm thick waveguides of different widths, according to an illustrative implementation. Similar to the simulations in FIGS. 4A and 4B, the simulations shown in FIGS. 6A and 6B were validated by establishing the group index experimentally using imbalanced Mach-Zehnder interferometer test structures. The results are in close agreement with the simulations, if measurement noise and uncertainty in waveguide dimensions due to lithography tolerances are taken into account. Note, however, the difference in horizontal scale between 6A and 6C, and 6B and 6D, respectively.

FIG. 6A shows simulated group index values for the lowest order TE mode (“ng_TE”) for a 1550 nm wavelength laser traveling in through 220 nm thick waveguides of different widths. FIG. 6C shows group index measurements under experimental conditions meant to replicate the simulation parameters. Similarly, FIGS. 6B and 6D respectively show simulated and measured group index values for the lowest order TM mode (“ng_TM”) under similar conditions.

FIGS. 6A-D show that the group index of the lowest-order TE and TM modes for a 1310 nm laser are roughly equivalent in a 220 nm thick waveguide having a width of 670 nm. Therefore, these simulations and measurements suggest that a 220×670 nm waveguide would exhibit reduced polarization dispersion for a 1550 nm laser. Thus, in some implementations, a dispersion-mitigating waveguide could have a thickness of approximately 220 nm and a width of approximately 670 nm. In some implementations, the dispersion-mitigating waveguide could have a thickness of approximately 220 nm and a width of approximately 600-740 nm. In some implementations, the dispersion-mitigating waveguide could have a thickness of approximately 220 nm and a width of approximately 500-840 nm.

In some implementations, the optical signal will have a finite bandwidth; for example, with a wavelength value in the range 1528-1565 nm. In such implementations, an optimal width close to, but greater or less than, 670 nm, can be chosen to optimize the polarization dispersion mitigation of the waveguide over the bandwidth of the optical signals.

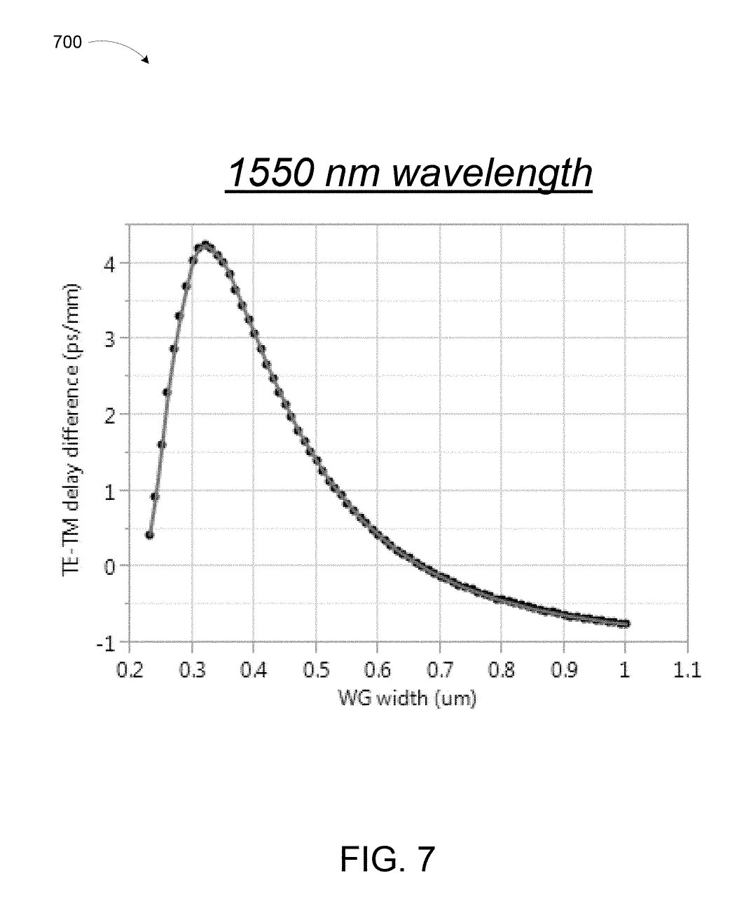

FIG. 7 shows simulated TE-TM delay difference values for a 1550 nm wavelength laser in 220 nm thick waveguides of different widths, according to an illustrative implementation. FIG. 7 represents the simulated group index values from FIG. 6A minus the simulated group index values from FIG. 6B at each simulated waveguide width. FIG. 7 shows that the lowest-order TE and TM modes, respectively, for a 1550 nm laser should have equivalent or approximately equivalent group index values in a 220×670 nm waveguide.

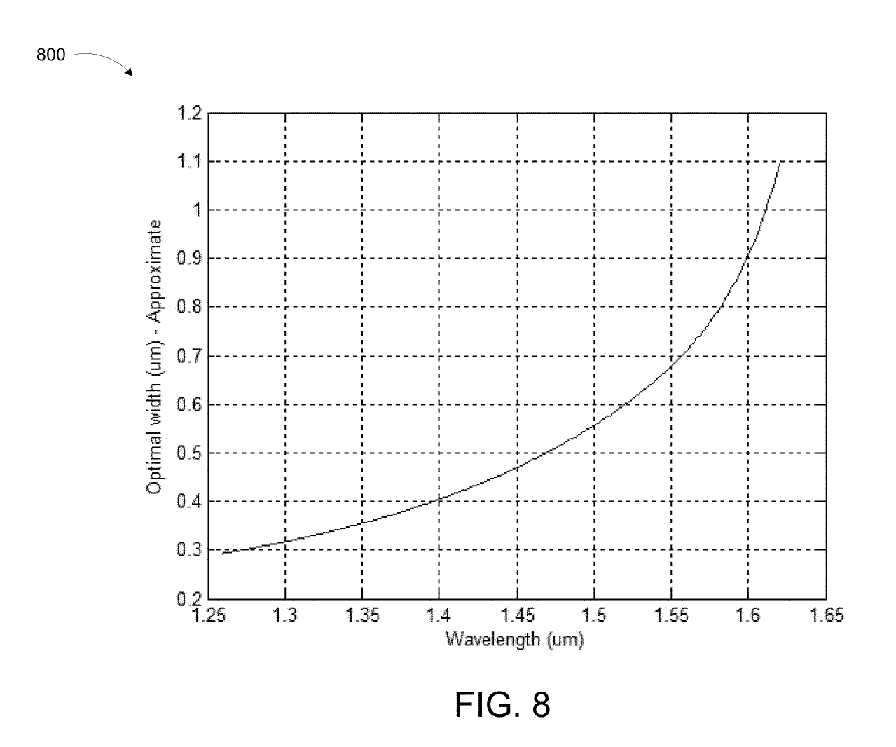

FIG. 8 shows the optimal waveguide width versus laser wavelength for reducing TE-TM delay difference values according to simulated values of TE and TM delay in a 220 nm thick waveguide, according to an illustrative implementation. The optimal width (Wₒ) values are calculated according to the following formula:

Wₒ=0.194+0.000114*e^{5.373*WL}+4.96*10⁻³⁰*e^{40.7*WL} (1)

The results 800 are given for optical signals having wavelengths (WL) from 1260-1620 nm. The results 800 agree with the data in FIGS. 4-7 for wavelengths of 1310 nm (an optimal waveguide width of approximately 320 nm) and 1550 nm (an optimal waveguide width of approximately 670 nm). 1310 nm and 1550 nm are common carrier wavelengths for optical signals, but the results 800 show that optimal waveguide widths can be determined in a similar fashion for other wavelengths.

In some implementations, Equation (1) can be generalized for other thicknesses t (in um) of the silicon. In Equation (2) below, the optimal waveguide width Wₒ (in um) is given as a function of wavelength WL (in um) and thickness t, where s is a scaling factor for t such that s=t/0.22. Equation (2) is valid at least over a region having a range of wavelengths WL from the greater of 1.26 um and 1.26*s at the low end to the lesser of 1.62 um or 1.62*s at the high end. For t=0.22 um, Equation (2) reduces to Equation (1).

Wₒ=[0.194+0.000114*e^{5.373*WL/s}+4.96*10^{-30*}e^{40.7*WL/s}]*s (2)

Generalizing Equation (1) for other thicknesses t is beneficial due to variations in silicon thickness. In practice, a wafer having a nominal starting substrate thickness of 0.22 um may end up having a slightly lower thickness following processing. The finished thickness can depend on the particular foundry or equipment that processes the wafer. A waveguide from one foundry or process may have a finished thickness t of 0.2144 um, while a waveguide produced by another foundry or process may have a finished thickness t of 0.2044 um. It is possible for the finished thickness to be as low as 0.200 um.

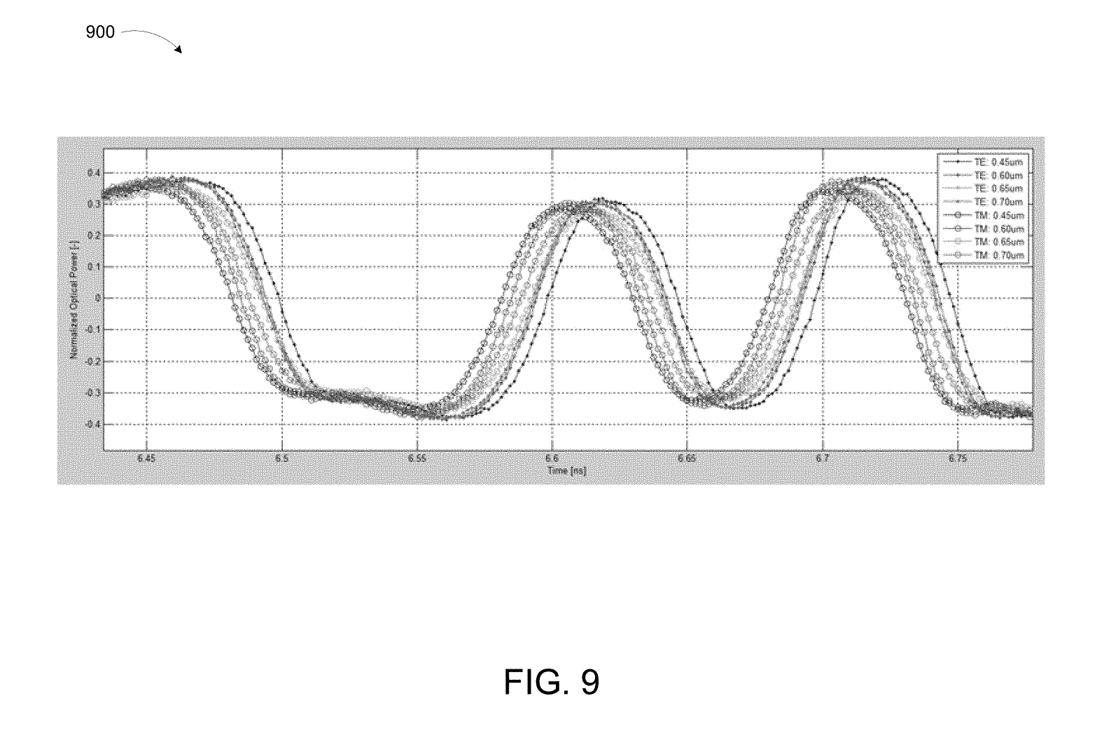

FIG. 9 shows the results 900 of direct delay measurements of TE and TM delay through 220 nm thick waveguides of various widths for both TE and TM modes of a 1550 nm laser, according to an illustrative implementation. The results 900 confirm a large delay difference for an optical signal traveling in a standard waveguide having a width of 450 nm for a 1550 nm optical signal. The results 900 also confirm low polarization dispersion at 650 nm, consistent with the group index simulations and measurements expressed in FIGS. 6-7.

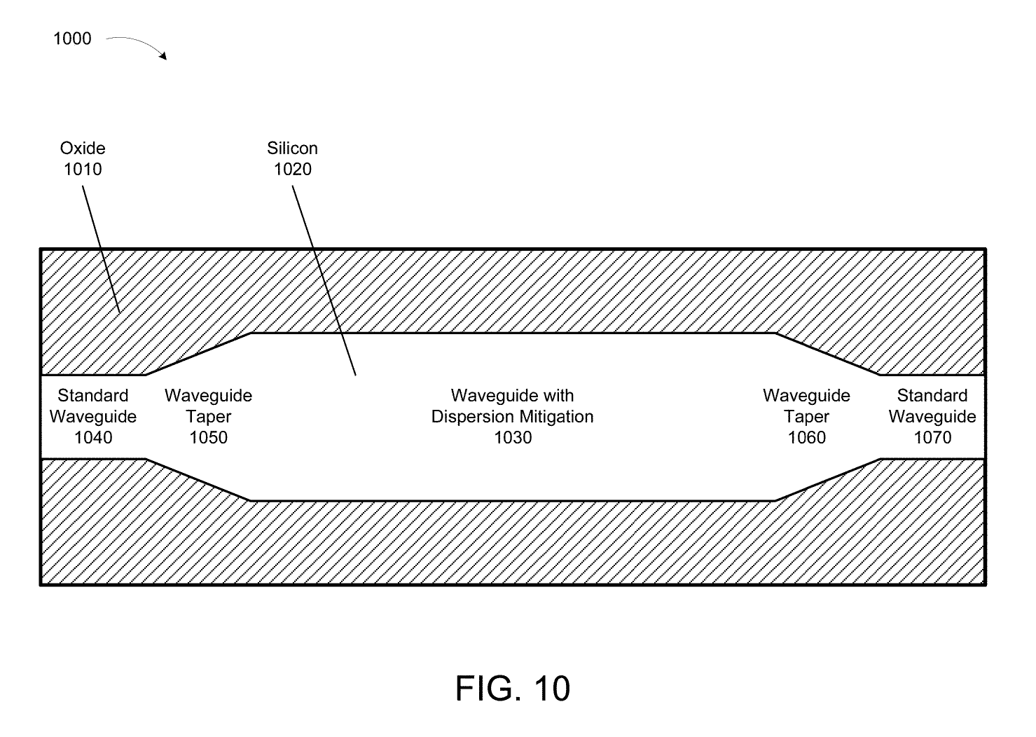

Even when optimal waveguide dimensions are used, however, special care must be taken to taper the waveguide to dimensions of a standard waveguide, which may be needed for joining the dispersion-mitigating waveguide with the edge couplers and photodiodes. Too gradual a taper may reduce the effectiveness of the polarization mitigation and excite higher order modes, while too abrupt a taper may excite higher order modes of the optical signal or cause excess loss. Improved tapering between standard waveguides and a polarization-mitigation waveguide is described below with reference to FIG. 10.

FIG. 10 illustrates a top view of a compound waveguide 1000 including a polarization dispersion-mitigating waveguide 1030 with waveguide tapers 1050 and 1060, according to an illustrative implementation. Similar to the waveguide 310 described previously, the compound waveguide 1000 can be made of silicon 1020 surrounded on several sides by an oxide 1010. The compound waveguide 1000 includes a first length of standard waveguide 1040, a first waveguide taper 1050, a dispersion-mitigating waveguide 1030, a second waveguide taper 1060, and a second length of standard waveguide 1070.

In some implementations, the standard waveguides 1040 and 1070 can have the standard waveguide dimensions of approximately 220×450 nm for a 1550 nm optical signal, or approximately 220×380 nm for a 1310 nm optical signal. In some implementations, the first standard waveguide 1040 can couple to an edge coupler, such as the edge coupler 115 previously described, for receiving an optical signal from an external source. In some implementations, the standard waveguide 1070 can couple to a photodetector, such as the photodiode 135 previously described, and couple the received optical signal into the photodetector for detection.

In some implementations, the first waveguide taper 1050 and the second waveguide taper 1060 can be optimized in a trade-off between low loss and no significant excitation of higher-order modes. In some implementations, the waveguide tapers 1050 and 1060 can have a length of approximately 2 um. In some implementations, the waveguide tapers 1050 and 1060 can have a length of approximately 1.5-2.5 um. In some implementations, the waveguide tapers 1050 and 1060 can have a length of approximately 1-4 um.

The dispersion-mitigated waveguide 1030 or the compound waveguide 1000 have applications beyond the transceiver module PIC described herein. For example, in some implementations, such waveguides could be used to improve polarization-dependent behavior of optical circuits in an optical switch. In addition, if other elements on the PIC display significant polarization dispersion of TE and TM modes, the waveguide width may be intentionally set to introduce a compensating effect; for example, delaying a TE mode relative to a TM mode following a component that has introduced an opposite delay.

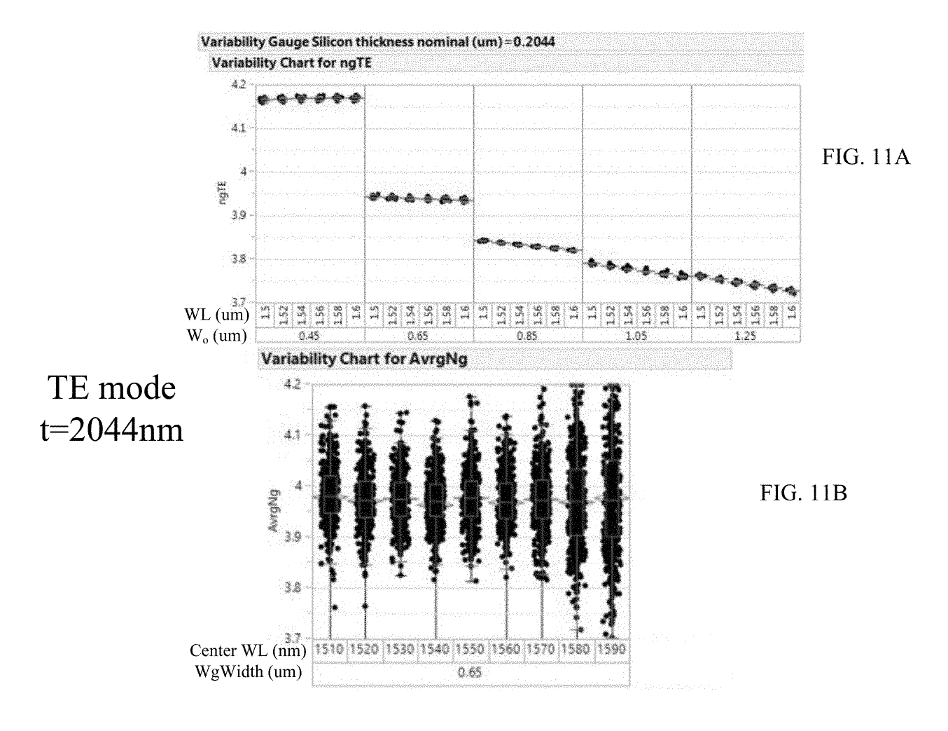

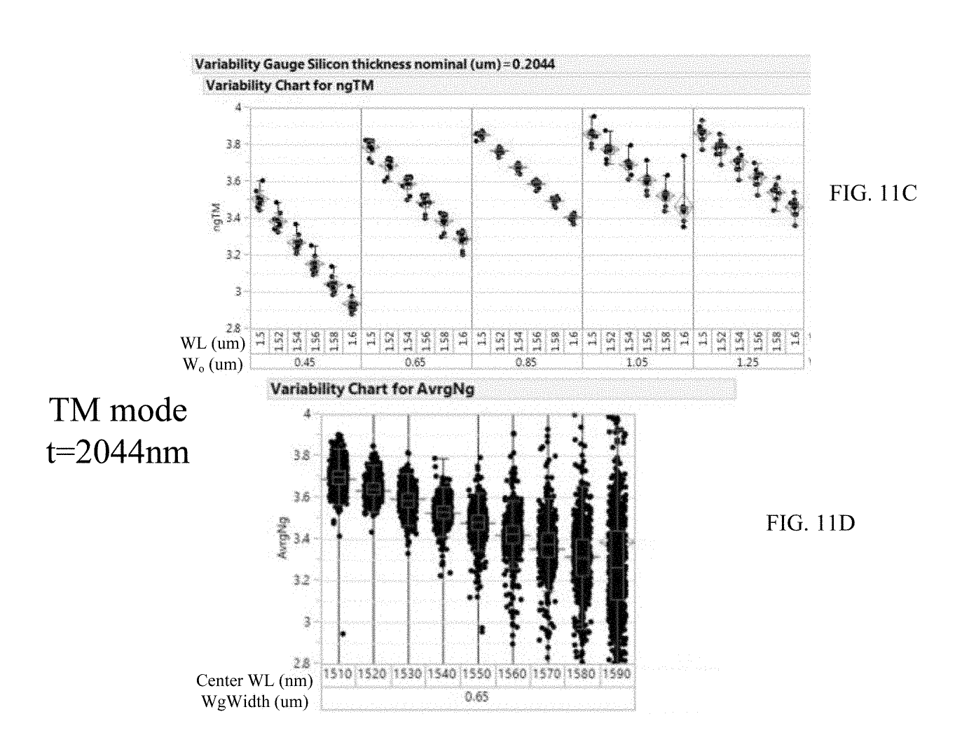

FIGS. 11A and 11B show simulated (A) and measured (B) group index values for TE modes of a 1.5-1.6 um wavelength laser in approximately 204.4 nm thick waveguides of different widths ranging from 0.45-1.25 um, according to an illustrative implementation. FIG. 11A shows simulation results of the group index, or group refractive index, n_{g} of the first TE mode of light having various wavelengths WL through a waveguide having a width Wₒ between 0.45 um and 1.25 um. FIG. 11B shows measurement results of the group index of the first TE mode of light having various wavelengths WL through a waveguide having a width Wₒ of 0.65 um. FIGS. 11A and 11B show that the simulations and measurements are in close agreement at this width.

FIGS. 11C and 11D show simulated (C) and measured (D) group index values for TM modes of a 1.5-1.6 um wavelength laser in approximately 204.4 nm thick waveguides of different widths ranging from 0.45-1.25 um, according to an illustrative implementation. FIG. 11C shows simulation results of the group index, or group refractive index, n_{g} of the first TM mode of light having various wavelengths WL through a waveguide having a width Wₒ between 0.45 um and 1.25 um. FIG. 11D shows measurement results of the group index of the first TE mode of light having various wavelengths WL through a waveguide having a width Wₒ of 0.65 um. FIGS. 11A and 11B show that the simulations and measurements are in close agreement at this width. Comparing the simulations of FIG. 11A and FIG. 11C indicates waveguide dimensions that will provide same or similar group index values for both the first TE mode and the first TM mode, thereby reducing polarization dispersion; for example, a width of about 0.85 um for a wavelength of 1500 nm, or a width of about 1.05 um for 1520 nm.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

References to “or” may be construed as inclusive so that any terms described using “or” may indicate any of a single, more than one, and all of the described terms. The labels “first,” “second,” “third,” and so forth are not necessarily meant to indicate an ordering and are generally used merely to distinguish between like or similar items or elements.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

What is claimed is:

1. A silicon-on-insulator photonic integrated circuit comprising:
a silicon dioxide substrate surrounding a silicon waveguide, wherein the silicon waveguide has a thickness between an upper side and a lower side and a width between lateral sides such that:
a first group index of a lowest-order TE mode of an optical signal is approximately equal to a second group index of a lowest-order TM mode of the optical signal.

2. The silicon-on-insulator photonic integrated circuit of claim 1, wherein the thickness and the width of the silicon waveguide are such that the silicon waveguide substantially attenuate higher-order TE and TM modes of the optical signal

3. The silicon-on-insulator photonic integrated circuit of claim 1, wherein the thickness and the width of the silicon waveguide are such that the silicon waveguide does not excite higher-order modes of the optical signal.

4. The silicon-on-insulator photonic integrated circuit of claim 1, wherein the optical signal has a wavelength of 1550 nm.

5. The silicon-on-insulator photonic integrated circuit of claim 4, wherein the thickness is approximately 220 nm and the width between the lateral sides is approximately 670 nm.

6. The silicon-on-insulator photonic integrated circuit of claim 1, wherein the optical signal has a wavelength of 1310 nm.

7. The silicon-on-insulator photonic integrated circuit of claim 6, wherein the thickness is approximately 220 nm and the width between the lateral sides is approximately 320 nm.

8. The silicon-on-insulator photonic integrated circuit of claim 1, wherein:
the silicon waveguide includes a middle section, a first taper at a first end of the middle section, and a second taper at a second end of the middle section opposite the first end;
the first taper joins the middle section with a first end section having a different width than the middle section, the first taper joining the lateral sides of the middle section with lateral sides of the first end section; and
the second taper joins the middle section with a second end section having a different width than the middle section, the second taper joining the lateral sides of the middle section with lateral sides of the second end section.

9. The silicon-on-insulator photonic integrated circuit of claim 8, wherein:
the middle section has a thickness of approximately 220 nm and a width of approximately 320 nm;
the first taper has a length of approximately 2 um; and
the second taper has a length of approximately 2 um.

10. The silicon-on-insulator photonic integrated circuit of claim 9, wherein:
the first end section is coupled with an edge coupler for receiving the optical signal and conveying it to the silicon waveguide; and
the second section is coupled with a photo detector for detecting the optical signal received at the edge coupler.

11. The silicon-on-insulator photonic integrated circuit of claim 8, wherein:
the middle section has a thickness of approximately 220 nm and a width of approximately 670 nm;
the first taper has a length of approximately 2 um; and
the second taper has a length of approximately 2 um.

12. The silicon-on-insulator photonic integrated circuit of claim 11, wherein:
the first end section is coupled with an edge coupler for receiving the optical signal and conveying it to the silicon waveguide; and
the second section is coupled with a photo detector for detecting the optical signal received at the edge coupler.

13. The silicon-on-insulator photonic integrated circuit of claim 1, wherein the width relates to the thickness for a given wavelength WL according to the following formula where Wo is the width and s is a scaling factor for the thickness t such that s=t/0.22:
Wₒ=[0.194+0.000114*e^{5.373*WL/s}+4.96*10⁻³⁰*e^{40.7*WL/s}]*s

14. The silicon-on-insulator photonic integrated circuit of claim 13, wherein the wavelength is greater than the greater of 1.26 um and 1.26*s and less than the lesser of 1.62 um or 1.62*s.

15. A polarization dispersion mitigating waveguide comprising:
a silicon waveguide surrounded by silicon dioxide on its upper, lower, and lateral sides, the silicon waveguide having a thickness of approximately 220 nm between the upper side and the lower side and a width of approximately 320 nm between the lateral sides.

16. The polarization dispersion mitigating waveguide of claim 15, wherein a first group index of a lowest-order TE mode of an optical signal having a wavelength of 1310 nm is approximately equal to a second group index of a lowest-order TM mode of the optical signal.

17. A polarization dispersion mitigating waveguide comprising:
a silicon waveguide surrounded by silicon dioxide on its upper, lower, and lateral sides, the silicon waveguide having a thickness of approximately 220 nm between the upper side and the lower side and a width of approximately 670 nm between the lateral sides.

18. The polarization dispersion mitigating waveguide of claim 17, wherein a first group index of a lowest-order TE mode of an optical signal having a wavelength of 1550 nm is approximately equal to a second group index of a lowest-order TM mode of the optical signal.

19. The polarization dispersion mitigating waveguide of claim 17, wherein the width relates to the thickness for a given wavelength WL according to the following formula where Wo is the width and s is a scaling factor for the thickness t such that s=t/0.22:
Wₒ=[0.194+0.000114*e^{5.373*WL/s}+4.96*10⁻³⁰*e^{40.7*WL/s}]*s

20. The polarization dispersion mitigating waveguide of claim 17, wherein the wavelength is greater than the greater of 1.26 um and 1.26*s and less than the lesser of 1.62 um or 1.62*s.
